(19) United States
(12) Patent Application Publication
(10) Pub. No.: US 2008/0052745 A1
(43) Pub. Date: Feb. 28, 2008

(54) Content playing method, system and receiving terminal for digital broadcast Service

(75) Inventors: Zhibin Li, Shenzhen (CN); Shengqiong Wang, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: HUAWEI TECHNOLOGIES CO., LTD.

(21) Appl. No.: 11/898,883

(22) Filed: Sep. 17, 2007

Related U.S. Application Data
(63) Continuation of application No. PCT/CN06/02161, filed on Aug. 24, 2006.

(30) Foreign Application Priority Data
Aug. 24, 2005 (CN) 200510096915.8

(51) Int. Cl. G06F 3/00

(52) U.S. Cl. 725/58

(57) ABSTRACT

A content playing method, system and receiving terminal, the method including: set priorities for broadcast contents; determine the contents to be played according to priorities of broadcast contents. The invention helps to solve broadcast contents conflicts by managing broadcast contents according to priorities. In addition, if priorities are set for broadcast contents on content servers and the priorities cannot be modified based on setting, it is easy for service provider to provide new services. For example, a service provider may provide broadcast content for free and force users to play advertisement in the broadcast contents.

### CROSS REFERENCE TO RELATED APPLICATIONS

This application is a continuation of International Application No. PCT/CN2006/002161, filed Aug. 24, 2006, which claims the priority of Chinese Application No. 200510096915.8, filed Aug. 24, 2005, the content of both of which is incorporated herein by reference.

### FIELD OF THE INVENTION

This invention relates to the communication field, in particular to a content playing method, system and receiving terminal for the digital broadcast service.

### BACKGROUND OF THE INVENTION

The digital broadcast service is used to provide the public with images, voice, multimedia and data. Information is sent to the public through universal receiving terminals by means of point-to-plane receiving. The receiving terminals receive data sent by content servers in the broadcast network and there is no reverse channel between a receiving terminal and a content server for them to interact.

The digital broadcast service covers a large amount of broadcast contents that are arranged based on a scheduler. With the scheduler, users can know playing contents, broadcast time and broadcast channels. The scheduler includes validity time, content broadcast or receiving time and content playing time, and so on. The scheduler is included in a digital broadcast guide sent by content servers to receiving terminals.

At present, the conflict in broadcast time of programs is not taken into account in arrangement of broadcast contents. A content provider can process contents provided by itself to avoid conflict but cannot control other providers. In addition, a content provider may provide multiple contents at one time. Therefore, conflict in broadcast contents is unavoidable. A user may subscribe to multiple broadcast contents, and it cannot be ensured that the playing time does not conflict. Conflict in broadcast contents may cause a lot of inconvenience to users when they are receiving broadcast. Users can not select to play a content by preference without losing those contents to be played later.

### SUMMARY OF THE INVENTION

The embodiment of the invention provides a content playing method for digital broadcast, including: setting priorities for broadcast contents; when broadcast contents conflict, determining a broadcast content to be played according to their priorities.

The embodiment of the invention also provides a content playing system for the digital broadcast service, including a content server, used to send digital broadcast service guide and broadcast contents to a receiving terminal; the receiving terminal, used to receive the digital broadcast service guide and the broadcast contents sent by the content server and play the broadcast contents locally; the content server is further used to set priorities for broadcast contents which are included in the digital broadcast service guide; the receiving terminal is further used to determine the broadcast content to be played by the priorities when the broadcast contents conflict during playing.

The embodiment of the invention also provides a content playing system for the digital broadcast service, including: a content server, used to send digital broadcast service guide and broadcast contents to a receiving terminal; the receiving terminal, used to receive broadcast contents sent by content servers and play the broadcast contents locally; the receiving terminal being further used to set priorities for the broadcast contents and determine a broadcast content to be played according to the priorities of the broadcast contents when the broadcast contents conflict.

The embodiment of the invention also provides a receiving terminal for the digital broadcast service, used to download broadcast contents and play the broadcast contents locally, wherein the receiving terminal is further used to set priorities for the broadcast contents, and determine a content to be played according to the priorities set for the broadcast contents when the broadcast contents conflict during playing.

### BRIEF DESCRIPTION OF THE DRAWINGS

FIG. 1 shows the structure of a content playing system for the digital broadcast service according to an embodiment of the invention;

FIG. 2 shows the flowchart of setting priorities for broadcast contents according to an embodiment of the invention;

FIG. 3 shows the flowchart of processing broadcast contents by the receiving terminal after the receiving terminal receives broadcast contents sent by content servers according to an embodiment of the invention.

### DETAILED DESCRIPTION OF THE EMBODIMENTS

It should be understood that the embodiments described below are used to explain the invention instead of limiting the invention.

To solve conflicts of contents in broadcast receiving and playing time for the digital broadcast service, priorities for broadcast contents are set, according to an embodiment of the invention, to ensure receiving and playing of contents with higher priorities in case of broadcast contents conflict.

### An Embodiment of the Invention

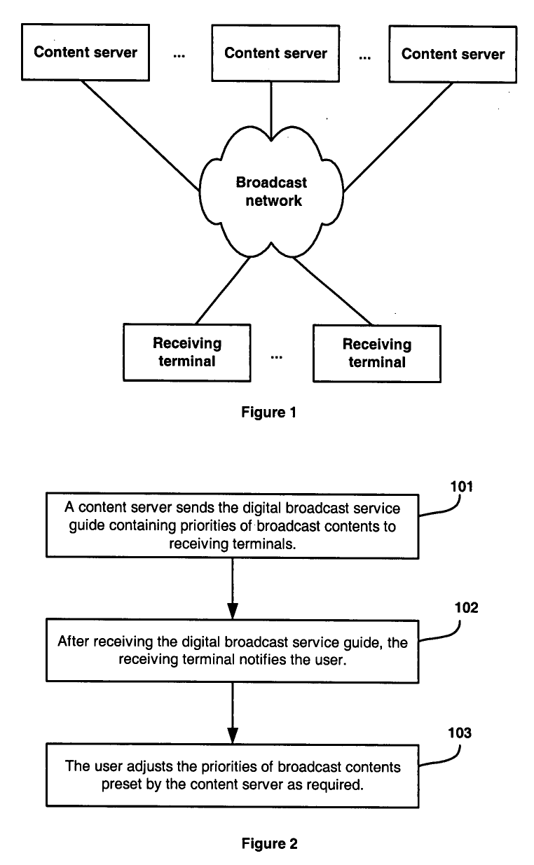

FIG. 1 shows the structure of a content playing system for the digital broadcast service according to an embodiment of the invention. The system includes one or more content servers and one ore more receiving terminals.

The content servers release a digital broadcast service guide to the receiving terminals through a broadcast network such as digital video broadcasting network (DVB), mobile network or Internet and send broadcast contents to the receiving terminals by following the digital broadcast service guide. The digital broadcast service guide includes service information and contents in the digital broadcast service, for example, content description, charge for contents on demand and the scheduler that informs users of available programs. It also includes settings of priorities for broadcast contents and of whether priorities may be modified. Content servers may be large or medium servers.

The receiving terminals download and play broadcast contents and may adjust the priorities of broadcast contents. In the case of broadcast contents conflict, receiving terminals determine the contents to be played locally according to the priorities. The receiving terminal further includes a storage device used to store contents that are not played in the case of broadcast contents conflict and to store subsequent data of the stored contents when playing the stored contents after a current content is played completely. The receiving terminal may be a communication terminal that downloads broadcast contents provided by content servers. For example, it may be a mobile phone, a personal computer (PC) or a personal digital assistant (PDA). The storage device may be a storage medium such as built-in random access memory (RAM) and hard disk.

FIG. 2 shows the flowchart of setting priorities for broadcast contents according to an embodiment of the invention, including the following steps:

Step 101: A content server sets priorities for broadcast contents according to their originality and popularity, and the setting is included in the digital broadcast service guide. The content server sends the digital broadcast service guide to receiving terminals.

When setting priorities, the content server may also set whether the specified priority of a broadcast content may be modified, which is also included in the digital broadcast service guide.

Step 102: After receiving the digital broadcast service guide, the receiving terminal of digital broadcast obtains the setting of priorities and notifies the user that the digital broadcast service guide has been received.

Step 103: The user adjusts the priorities of broadcast contents set by the content server as required and does not adjust those contents whose priorities are not allowed to be adjusted.

It should be noted that, to ensure users may obtain the latest broadcast contents and their priorities, the content server needs to send the digital broadcast service guide to receiving terminals before sending broadcast contents. The content server may also update the setting of priorities in the service guide and send the service guide to receiving terminals periodically.

Note: In step 101, a field of priorities description may be added to the content description of the digital broadcast service guide to indicate the settings of priorities of broadcast contents and of whether priorities may be modified.

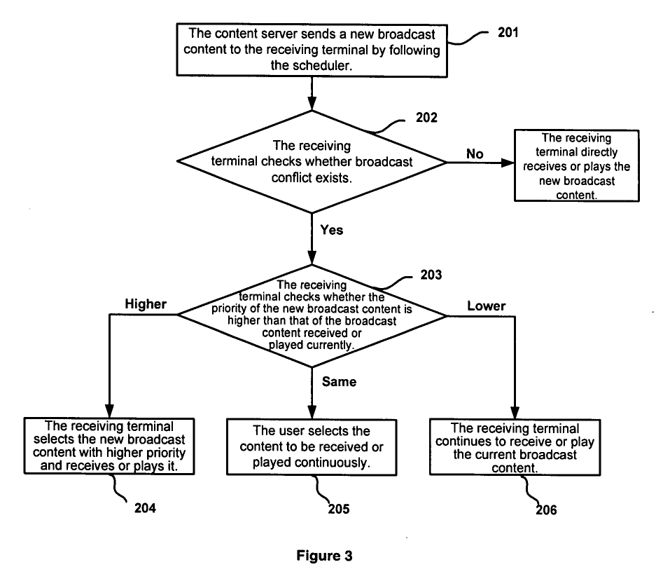

FIG. 3 shows the flowchart of processing broadcast contents by a receiving terminal after the terminal receives broadcast contents sent by the content server according to an embodiment of the invention, including the following steps:

Step 201: The content server sends a new broadcast content to the receiving terminal by following the scheduler.

Step 202: After receiving the broadcast content sent by the content server, the receiving terminal checks whether broadcast contents conflict exists. If yes, the process goes to step 203; if not, the receiving terminal directly receives or plays the new broadcast content.

Step 203: The receiving terminal checks whether the priority of the new broadcast content is higher than that of the broadcast content received or played currently. If yes, the process goes to step 204; if lower, the process goes to step 206; if the priorities of the two contents are the same, the process goes to step 205.

Step 204: The receiving terminal directly selects the new broadcast content with higher priority to receive or play it.

Step 205: The receiving terminal prompts the user to select which content to process. The content server continues to send the broadcast content selected by the user, and the receiving terminal plays the broadcast content selected by the user.

Step 206: The receiving terminal continues to receive or play the current broadcast content.

In steps 204, 205 and 206, upon receiving a new broadcast content, the receiving terminal may also display a broadcast prompt for the user, notifying the user that a new content needs to be received or played. If the storage capacity permits, the receiving terminal stores the broadcast contents that have not been played. After the selected broadcast content is received or played, the receiving terminal notifies the user to play the stored contents if the stored broadcast contents are within a validity period. When playing the stored contents, the receiving terminal may continue to receive and store subsequent data of the broadcast content interrupted last time if the broadcast content interrupted last time is being received.

The priorities of broadcast contents are set flexibly by content providers in content servers according to the service requirement. For example, priorities may include three levels: high, medium and low, or five levels: highest, high, medium, common and low. The following further describes the functions of priorities in playing according to the above embodiment of the invention.

Priorities include four levels, that is, 0, 1, 2 and 3 from the highest to the lowest.

0: highest priority. In the case of broadcast contents conflict, ensure playing or receiving of contents whose priorities are 0 by preference.

1: second highest priority. If broadcast contents conflict and the contents whose priorities are 0 do not exist, ensure receiving or playing of the contents whose priorities are 1 by preference. If the contents whose priorities are 0 exist and the storage capacity of the receiving terminal is enough, the receiving terminal stores the contents whose priorities are 1 and provides a broadcast prompt to the user. After the contents whose priorities are 0 are played or received completely, if the contents whose priorities are 1 are in the validity period, the receiving terminal starts to play or receive the contents of priority 1.

2: common priority. If broadcast contents conflict and the contents whose priorities are higher than 2 do not exist, ensure receiving or playing of contents whose priorities are 2 by preference. If the contents whose priorities are higher than 2 are being received or played, the receiving terminal provides a broadcast prompt to the user, stops receiving or playing contents of priority 2 and starts to receive or play contents of higher priorities.

3: lowest priority. If broadcast contents conflict and the contents whose priorities are higher than 3 do not exist, ensure receiving or playing of contents whose priorities are 3 by preference. If the contents whose priorities are higher than 3 are being received or played, the receiving terminal stops receiving or playing contents of priority 3 and starts to receive or play contents of higher priorities.

The above embodiment shows that management of broadcast contents by priorities helps to solve broadcast contents conflicts. In addition, if priorities are set for broadcast contents on the content server and the priorities cannot be modified, it is easy for content providers to provide new services. For example, a service provider may provide broadcast contents for free and force users to play advertisements added in the contents.

### Another Embodiment of the Invention

Similar to the above embodiment, a content playing system for the digital broadcast service includes one ore more content servers and one or more receiving terminals.

The content servers release the digital broadcast service guide to the receiving terminals through a broadcast network such as DVB, mobile network or Internet and send the broadcast contents to the receiving terminals by the digital broadcast service guide. The digital broadcast service guide includes service information and content information of the digital broadcast service, for example, content description, charge for contents on demand and the scheduler informing users of available programs.

The receiving terminals download broadcast contents, set priorities for broadcast contents and play contents locally according to the priorities of the contents. The receiving terminal may further include a storage device used to store contents that are not played in the case of broadcast contents conflict and to store subsequent data of the stored contents when playing the stored contents after a current content is played completely.

After receiving broadcast contents sent by a content server, a receiving terminal plays the contents in the same way as it does in the first embodiment of the invention.

The second embodiment of the invention shows that the system and method may help to solve broadcast contents conflicts by managing the priorities of broadcast contents. Different from the first embodiment, however, a content server cannot manage priorities of some important contents in this embodiment. As a result, the content server cannot realize specified broadcast services. For example, it cannot force users to play advertisements added in broadcast contents during playing of free contents.

In the embodiments of the invention, contents include various broadcast contents, programs and services provided by content servers. Playing includes receiving, downloading or playing of broadcast contents.

Although the invention has been described through some preferred embodiments, the invention is not limited to such embodiments. It is intended that any change, equivalent replacement or improvement within the spirit and principle of the invention be included in the scope of protection of the invention.

What is claimed is:

1. A content playing method for digital broadcast service, comprising:
setting priorities for broadcast contents;
when broadcast contents conflict, determining a broadcast content to be played according to their priorities.

2. The method of claim 1, wherein when broadcast contents conflict, determining a broadcast content to be played according to their priorities further comprises:
when broadcast contents with a same priority conflict, select a broadcast content from the conflicting contents to play;
when broadcast contents with different priorities conflict, playing the broadcast content with a higher priority.

3. The method of claim 1, further comprising:
when broadcast contents conflict, storing broadcast contents that have not been played;
after playing the current broadcast content completely, playing the stored broadcast contents if the stored broadcast contents are in a validity period.

4. The method of claim 3, further comprising, when playing the stored broadcast contents after playing the current broadcast content completely, if subsequent data of the stored broadcast contents is being received, continuing to receive and store the subsequent data.

5. The method of claim 1, further comprising, when setting priorities for broadcast contents, setting whether the priorities can be modified.

6. The method of claim 5, wherein when the priority of a broadcast content can be modified based on setting, adjusting the priority according to a user's requirement before playing.

7. A content playing system for digital broadcast service, comprising
a content server, used to send digital broadcast service guide and broadcast contents to a receiving terminal;
the receiving terminal, used to receive the digital broadcast service guide and the broadcast contents sent by the content server and play the broadcast contents locally; wherein,
the content server is further used to set priorities for broadcast contents which are included in the digital broadcast service guide;
the receiving terminal is further used to determine the broadcast content to be played by the priorities when the broadcast contents conflict during playing.

8. The system of claim 7, wherein the content server is further used to set whether the priority of a broadcast content can be modified and the setting is included in the digital broadcast service guide.

9. The system of claim 7, wherein determining the broadcast content to be played by the priorities when the broadcast contents conflict during playing comprises:
when broadcast contents with a same priority conflict, selecting a broadcast content to play from the conflicting broadcast contents;
when broadcast contents with different priorities conflict, playing a broadcast content with a higher priority.

10. The system of claim 7, wherein the receiving terminal is further used to modify the priorities of broadcast contents whose priorities are allowed to be modified.

11. The system of claim 7, wherein the receiving terminal further comprises a storage device used to store broadcast contents that have not been played when broadcast contents conflict.

12. The system of claim 11, wherein the storage device is further used to store subsequent data of the stored broadcast contents when playing the stored broadcast contents after a current broadcast content is played completely.

13. A content playing system for digital broadcast service, comprising:
a content server, used to send digital broadcast service guide and broadcast contents to a receiving terminal;
the receiving terminal, used to receive broadcast contents sent by content servers and play the broadcast contents locally; wherein
the receiving terminal is further used to set priorities for the broadcast contents and determine a broadcast content to be played according to the priorities of the broadcast contents when the broadcast contents conflict.

14. The system of claim 13, wherein determining a broadcast content to be played according to the priorities when the broadcast contents conflict further comprising:
when broadcast contents with a same priority conflict, selecting a broadcast content to play from the conflicting broadcast contents;
when broadcast contents with different priorities conflict, playing a broadcast content with a higher priority.

15. The system of claim 13, wherein the receiving terminal further comprises a storage device used to store broadcast contents that have not been played when broadcast contents conflict.

16. The system of claim 15, wherein the storage device is further used to store received subsequent data of the stored broadcast contents when playing the stored broadcast contents after a current broadcast content is played completely.

17. A receiving terminal for digital broadcast service, used to download broadcast contents and play the broadcast contents locally, wherein the receiving terminal is further used to set priorities for the broadcast contents, and determine a content to be played according to the priorities set for the broadcast contents when the broadcast contents conflict during playing.

18. The receiving terminal of claim 17, wherein when broadcast contents conflict during playing, determining a broadcast content to be played according to the priorities further comprising:
when broadcast contents with a same priority conflict, selecting a broadcast content to play from the conflicting broadcast contents;
when broadcast contents with different priorities conflict, selecting a content with a higher priority to play.

19. The receiving terminal of claim 17, further comprising a storage device used to store broadcast contents that have not been played when broadcast contents conflict.

20. The receiving terminal of claim 19, wherein the storage device is further used to store received subsequent data of the stored broadcast contents when playing the stored broadcast contents after a current broadcast content is played completely.
